(19) United States
(12) Patent Application Publication
(10) Pub. No.: US 2009/0123749 A1
(43) Pub. Date: May 14, 2009

(54) Unit Optical Fiber

(75) Inventors: Keisuke Ui, Tokyo (JP); Atsuyoshi Seno, Tokyo (JP); Tetsuo Sato, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: THE FURUKAWA ELECTRIC CO., LTD., TOKYO (JP)

(21) Appl. No.: 11/910,484

(22) PCT Filed: Mar. 23, 2007
(86) PCT No.: PCT/JP2007/057018

§ 371 Date: Oct. 2, 2007

(30) Foreign Application Priority Data
Mar. 23, 2006 (JP) 2006-080587

(51) Int. Cl. B32B 17/10

(52) U.S. Cl. 428/375

(57) ABSTRACT

The present invention provides an optical fiber superior in yellowing resistance. An optical fiber according to the present invention has a coating made from a UV curable resin formed on the outer surface of a bare optical glass fiber, and is characterized in that the coated material includes an unreacted photoinitiator in an amount of 2.4×10⁻³ mole equivalent or less in 1 g of the material. The optical fiber is characterized in that the UV curable resin includes urethane acrylate, a polyisocyanate component in the urethane acrylate is an aromatic polyisocyanate, and tolylene diisocyanate is used as the aromatic polyisocyanate.

### TECHNICAL FIELD

The present invention relates to an optical fiber with adequate yellowing resistance.

### BACKGROUND ART

An optical fiber has a general structure having: a soft primary coating formed on the outer surface of a bare glass fiber; and a hard secondary coating further formed on the outer surface thereof. A UV curable resin is frequently used as a material for the primary coating and the secondary coating.

Urethane acrylate is known as the UV curable resin to be used for the coating material for the optical fiber. However, some materials coated on conventional coated optical fibers have easily changed the quality affected by heat or light, have especially shown coloration or discoloration such as yellowing if having been left under the condition of light exposure as in the outdoor or under a fluorescent lamp or under a hot condition, for a long period of time, and have thus been inferior in so-called weathering resistance and heat resistance. This is considered to be induced by the phenomenon that when an optical fiber is exposed to the light, a photoinitiator remaining in a coating decomposes and produces a free radical to change the resin into yellow.

In order to solve this problem, a technique of, for instance, using a coating material containing a particular oxidation inhibitor is described in Japanese Patent Application Laid-Open No. 2001-316434, Japanese Patent Application Laid-Open No. 2002-264276, Japanese Patent Application Laid-Open No. 2003-103717 and Japanese Patent Application Laid-Open No. 2003-104760, which is formed of a compound having a structure expressed by the following General Formula (1) in which an R group is characterized by a methyl group. However, even when using these oxidation inhibitors, if the coating material contained an aromatic polyisocyanate (e.g. tolylene diisocyanate) for the polyether-based urethane(meth)acrylate, the optical fiber occasionally showed decreased yellowing resistance. It is known that a compound having a phenolic group generally tends to form a quinone structure affected by a free radical and turn into yellow.

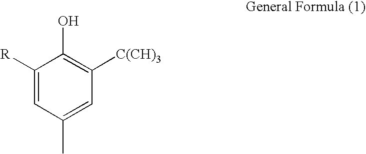

In order to solve the problem, a technique of using an alicyclic polyisocyanate for a polyisocyanate component is described in Japanese Patent Application Laid-Open No. H04-021546 (Japanese Patent Publication No. H08-025776) and Japanese Patent Application Laid-Open No. 2000-351920.

### DISCLOSURE OF THE INVENTION

However, there is a case in which an optical fiber can not help using an aromatic polyisocyanate from the viewpoint of the reactivity and physical properties of a cured material. A coating material which employs the aromatic polyisocyanate but has adequate yellowing resistance is demanded also because the aromatic polyisocyanate is generally inexpensive. An object of the present invention is to provide an optical fiber having the adequate yellowing resistance even when employing the coating material containing the aromatic polyisocyanate.

An optical fiber according to the present invention has a coating made from a UV curable resin formed on an outer surface of a bare optical glass fiber, and is characterized in that the coated material includes an unreacted photoinitiator in an amount of 2.4×10⁻³ mole equivalent or less in 1 g of the material. The UV curable resin includes urethane acrylate which may contain an aromatic polyisocyanate as a polyisocyanate component of the urethane acrylate. The UV curable resin may employ tolylene diisocyanate for the aromatic polyisocyanate.

The optical fiber according to the present invention shows adequate yellowing resistance even when using the aromatic polyisocyanate as the polyisocyanate component of the coating material.

### BRIEF DESCRIPTION OF THE DRAWING

FIG. 1 shows a sectional view of an optical fiber according to the present invention;

FIG. 2 illustrates an optical fiber array for measuring yellowing resistance; and

FIG. 3 illustrates two overlapped optical fiber arrays.

### BEST MODES FOR CARRYING OUT THE INVENTION

A photoinitiator needs to be excessively added into a UV curable resin in consideration of its absorbance and the quantum efficiency for radical formation, in order to optimize reaction efficiency. However, if an unreacted photoinitiator would remain in a coated material after having been cured, the unreacted photoinitiator is decomposed by being irradiated later with light to form a free radical which consumes an oxidation inhibitor. The phenomenon occasionally aggravates weather resistance and causes a discoloration of an aromatic polyisocyanate. Accordingly, it is preferable in general for the photoinitiator to remain as little as possible after the coating material has been cured.

On the other hand, in a secondary coating material is used a combination of a fast curing acylphosphine-oxide photoinitiator and a surface curing acetophenone photoinitiator in general, so that it is improved in heat resistance, weathering resistance and surface properties, as is described in Japanese Patent Application Laid-Open No. H02-248470 and Japanese Patent Application Laid-Open No. H04-006125. The acylphosphine-oxide photoinitiator can be decomposed into a deep layer because it cannot absorb light in the UV range of wavelength any longer by photodecomposition, whereas the acetophenone photoinitiator is hardly decomposed into the deep layer by irradiation because it can still absorb light in such a range of wavelength even after decomposition. In addition, when a photoinitiator with a low absorption coefficient is used in a coating material, the photoinitiator needs to be excessively added, because of having a low reaction efficiency.

Such a problem is solved by controlling an amount of an unreacted photoinitiator in 1 g of a coated material on an optical fiber to 2.4×10⁻³ mole equivalent or less.

The present invention will be now described in more detail based on examples, but the present invention is not limited to these examples.

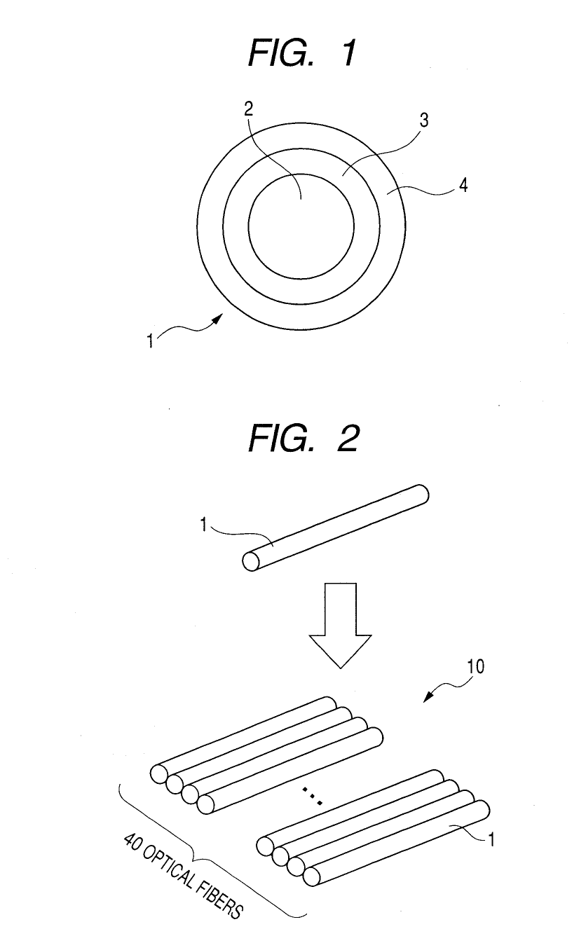

FIG. 1 shows a sectional view of an optical fiber according to the present invention. The form of the optical fiber to which the present invention can be applied is not limited in particular, but can include a form where it has a soft primary layer and a hard secondary layer of a UV curable resin dual-coated on the outer surface of an optical glass fiber, such as a silica glass fiber or a multicomponent glass fiber, with an outside diameter of 125 μm.

Optical fibers were produced by using a primary material and each secondary material shown below.

A base resin for the primary material was prepared by the steps of: preparing an oligomer by urethane-bonding tolylene diisocyanate that is an aromatic polyisocyanate to both ends of polypropylene glycol with a molecular weight of 3,000, and further urethane-bonding hydroxyethyl acrylate to both ends thereof; and blending 60 parts of the oligomer, 30 parts of nonylphenol EO-modified acrylate (product made by TOAGOSEI CO., LTD. ARONIXM-113) and 10 parts of n-vinyl caprolactam (product made by ISP Corp.).

A base resin for the secondary material was prepared by the steps of: preparing an oligomer by urethane-bonding tolylene diisocyanate that is an aromatic polyisocyanate to both ends of polypropylene glycol with a molecular weight of 1,000, and further urethane-bonding hydroxyethyl acrylate to both ends thereof; and blending 60 parts of the oligomer, 20 parts of isobornyl acrylate (product made by KYOEISHA CHEMICAL Co., LTD LIGHT-ACRYLATE IB-XA) and 20 parts of tricyclodecanedimethylol diacrylate (product made by KYOEISHA CHEMICAL Co., LTD LIGHT-ACRYLATE DCP-A).

An employed oxidation inhibitor was not such a particular compound as is characterized in that a group (R) in a compound having a structure represented by the following General Formula (1) is a methyl group, but a general hindered phenolic oxidation inhibitor of 2,2-thio-diethylenebis-[3-(3,5-di-tert-butyl-4-hydroxyphenyl)propionate] (product made in Ciba Specialty Chemicals, IRGANOX 1035), which is a compound having a structure expressed by the following General Formula (1), wherein the group (R) is a tert-butyl group. Specifically, one part of the oxidation inhibitor was added to each of a primary material and a secondary material.

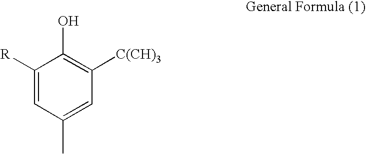

In addition, an acylphosphine-oxide photoinitiator, 2,4,6-trimethylbenzoyl diphenylphosphine oxide (product made by BASF Lucirin (registered trademark) TPO) was added to a primary material. The acylphosphine-oxide photoinitiator, Lucirin. (registered trademark) TPO and an acetophenone photoinitiator, 1-hydroxycyclohexyl phenylketone (product made by Ciba Specialty Chemicals, IRGACURE (registered trademark) 184) were added to a secondary material.

Optimal amounts of acylphosphine-oxide photoinitiators (photoinitiator (A) in Table 1) to be added to a primary material and a secondary material was determined on the basis of a curing rate (ratio of Young's modulus when the materials are little irradiated to that when much irradiated). Examples 1 to 3 and Comparative Examples 1 and 2 were prepared by changing the amount of an acetophenone photoinitiator (photoinitiator B in Table 1) to be added into the secondary material, which does not greatly affect the curing rate. The amount of an unreacted photoinitiator and yellowing resistance were examined on the obtained optical fiber. Results are shown in Table 1 (unit in parentheses is ×10⁻³ mole equivalent).

TABLE 1

| | | | | Com. | Com. |
|---|---|---|---|---|---|
| | Ex. 1 | Ex. 2 | Ex. 3 | Ex. 1 | Ex. 2 |
| Photoinitiator (A) in primary material | 2.3 (6.6) | | | | |
| (Lucirin (registered trademark) TPO, wt. %, | | | | | |
| unit in parentheses is ×10⁻³ mole equivalent) | | | | | |
| Photoinitiator (A) in secondary material | 1.6 (4.6) | | | | |
| (Lucirin (registered trademark) TPO, wt. %, | | | | | |
| unit in parentheses is ×10⁻³ mole equivalent) | | | | | |
| Amount (B) of photoinitiator in secondary | 0.05 | 0.3 | 0.6 | 1.0 | 2.1 |
| material (IRGACURE (registered trademark) | (0.24) | (1.5) | (2.9) | (4.9) | (10) |
| 184, wt. %, unit in parentheses is ×10⁻³ mole | | | | | |
| equivalent) | | | | | |
| Amount of unreacted Lucirin (registered | 1.5 | | | | |
| trademark) TPO in 1 g of coated material (×10⁻³ | | | | | |
| mole equivalent) | | | | | |
| Amount of unreacted IRGACURE (registered | 0.073 | 0.44 | 0.87 | 1.5 | 3.1 |
| trademark) 184 in 1 g of coated material (×10⁻³ | | | | | |
| mole equivalent) | | | | | |
| Total amount of unreacted photoinitiator in 1 g | 1.6 | 1.9 | 2.4 | 2.9 | 4.5 |
| of coated material (×10⁻³ mole equivalent) | | | | | |
| Yellowing (ΔYI after having been left for 30 | 1 | 2 | 4 | 7 | 12 |
| days under fluorescent lamp) | | | | | |

Each type of the resultant optical fibers were for the amount of the unreacted photoinitiator and yellowing measured according to the following procedures: weighing 1 g of the optical fibers; extracting compounds therein by using a chloroform/methanol mixture solvent; and subjecting the mixture solvent to HPLC analysis. Inertsil ODS-3 (No. 2-214) of 3.0×250 mm was used as a column, and an acetonitrile/water mixture was used as a mobile phase.

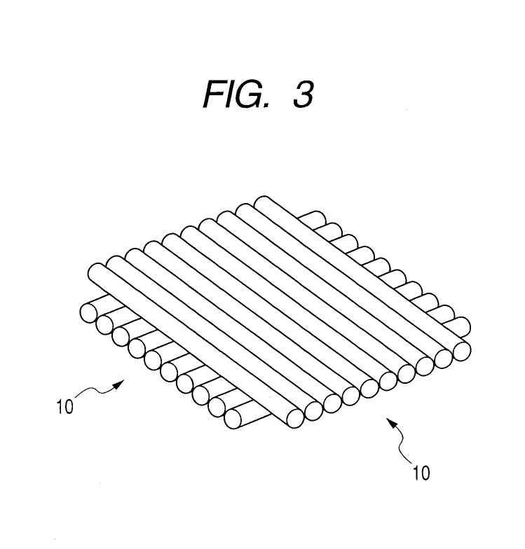

Yellowing was measured by the following steps of: preparing two optical fiber arrays 10 shaped like a bamboo blind by arranging 40 optical fibers 1 in a width direction as is shown in FIG. 2; subsequently, stacking these optical fiber arrays 10 so that the longitudinal directions of optical fibers 1 can be approximately orthogonal as shown in FIG. 3; measuring a YI value with SPECTROPHOTOMETER SE2000 (product made by Nippon Denshoku Industries Co., Ltd.); then, placing the optical fiber arrays 10 at a position of 30 cm below a 30 W fluorescent lamp so that each arranged face of the two optical fiber arrays 10 can be irradiated with the fluorescent lamp; leaving them at rest at room temperature for 30 days; afterward, stacking the optical fiber arrays 10 so that the face having been irradiated with the fluorescent lamp directs upward and the longitudinal directions of the optical fibers 1 become approximately orthogonal; measuring the YI value of the optical fiber arrays 10; and then, calculating the change ΔYI between values YI before and after the irradiation with the fluorescent lamp from the obtained values YI.

If a value ΔYI is not less than 5, when the outer surface of the optical fiber is coated with an ultraviolet curing coloring resin for discrimination, the tint of the resin would change, which may prevent its identification, so that the value ΔYI is preferably controlled to 5 or less.

In order to control a yellowing resistance ΔYI after having been left for 30 days under a fluorescent lamp to 5 or less, it is understood from Table 1 that a total amount of an unreacted photoinitiator has only to be controlled to 2.4×10⁻³ mole equivalent or less in 1 g of a coated material (the total coated material including a primary material and a secondary material) on the optical fiber.

In addition, optical fibers in Examples 1 to 3 show adequate yellowing resistance even when having used an aromatic polyisocyanate for a polyisocyanate component of a coating material and further when having used the above described general oxidation inhibitor having the General Formula (1) in which the group (R) is not a methyl group.

An optical fiber having no acetophenone photoinitiator added in a secondary material was prepared to try to draw it, but it could not be wound up because its surface was not cured well and highly frictional. Accordingly, the secondary material needs to contain the acetophenone photoinitiator even if it is in a small amount.

1. An optical fiber having a coating made from a UV curable resin formed on the outer surface of a bare optical glass fiber, characterized in that the coated material comprises an unreacted photoinitiator in an amount of 2.4×10⁻³ mole equivalent or less in 1 g of the material.

2. The optical fiber according to claim 1, characterized in that the UV curable resin comprises urethane acrylate and a polyisocyanate component in the urethane acrylate is an aromatic polyisocyanate.

3. The optical fiber according to claim 2, characterized in that the aromatic polyisocyanate is tolylene diisocyanate.
